(19) United States
(12) Patent Application Publication
(10) Pub. No.: US 2010/0140434 A1
(43) Pub. Date: Jun. 10, 2010

(54) SUSPENSION DEVICE

(76) Inventor: Donald Schmidt, Faust (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/630,773

(22) Filed: Dec. 3, 2009

(30) Foreign Application Priority Data
Dec. 4, 2008 (CA) 2646912

(51) Int. Cl. F16S 5/00

(52) U.S. Cl. 248/323

(57) ABSTRACT

A suspension device has a first body and a second body which, when secured together, define a channel in between to accommodate an elongated horizontal member. Each of the first body and the second body includes a suspension plate having a suspension plate aperture positioned intermediate the upper end and lower end; a lower mounting plate extending perpendicularly from the inside face at the lower end of the suspension plate; and an upper mounting plate extending perpendicularly from the inside face at the upper end of the suspension plate. The first body and the second body are secured together around an elongated horizontal member by overlapping the lower mounting plates and extending a first fastener though a lower mounting plate aperture of both the first and second bodies, and by extending a second fastener through the suspension plate aperture of the first and second bodies.

### FIELD

The present invention relates to a suspension device used to suspend objects from beams and other elongated horizontal members.

### BACKGROUND

There are suspension devices that hook over a beam or other elongated horizontal member. A drawback of such devices is that they can become dislodged. There are suspension devices that are capable of securely attaching to a beam or other elongated horizontal member, but they are unduly complex. There is a need for a suspension device of relatively simple construction that can be attached to a beam or other elongated horizontal member in a secure manner.

### SUMMARY

There is provided a suspension device, comprising: a first body and a second body which, when secured together, define a channel in between to accommodate an elongated horizontal member. Each of the first body and the second body have a suspension plate having an inside face, an outside face, an upper end and a lower end. The suspension plate has a suspension plate aperture positioned intermediate the upper end and lower end that extends between the inside face and the outside face. A lower mounting plate is integrally formed with and extends perpendicularly from the inside face at the lower end of the suspension plate. The lower mounting plate has a lower mounting plate aperture extending therethrough. An upper mounting plate is integrally formed with and extending perpendicularly from the inside face at the upper end of the suspension plate. A remote end of the upper mounting plate carries an engagement profile. The first body and the second body are secured together around an elongated horizontal member by overlapping the lower mounting plate of the first body and the lower mounting plate of the second body and extending a first fastener though the lower mounting plate aperture of both the first body and the second body and by extending a second fastener through the suspension plate aperture of both the first body and the second body to bring the engagement profile on the upper mounting plate of the first body into engagement with the engagement profile on the upper mounting plate of the second body. There is also means to suspend an object from the first fastener.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is an end elevation view of a suspension device.

FIG. 2 is an exploded end elevation view of the suspension device.

FIG. 3 is an end elevation view of the suspension device gripping a beam.

FIG. 4 is a side elevation view of the suspension device gripping a beam.

FIGS. 5 and 6 are side elevation views of alternative suspension devices.

### DETAILED DESCRIPTION

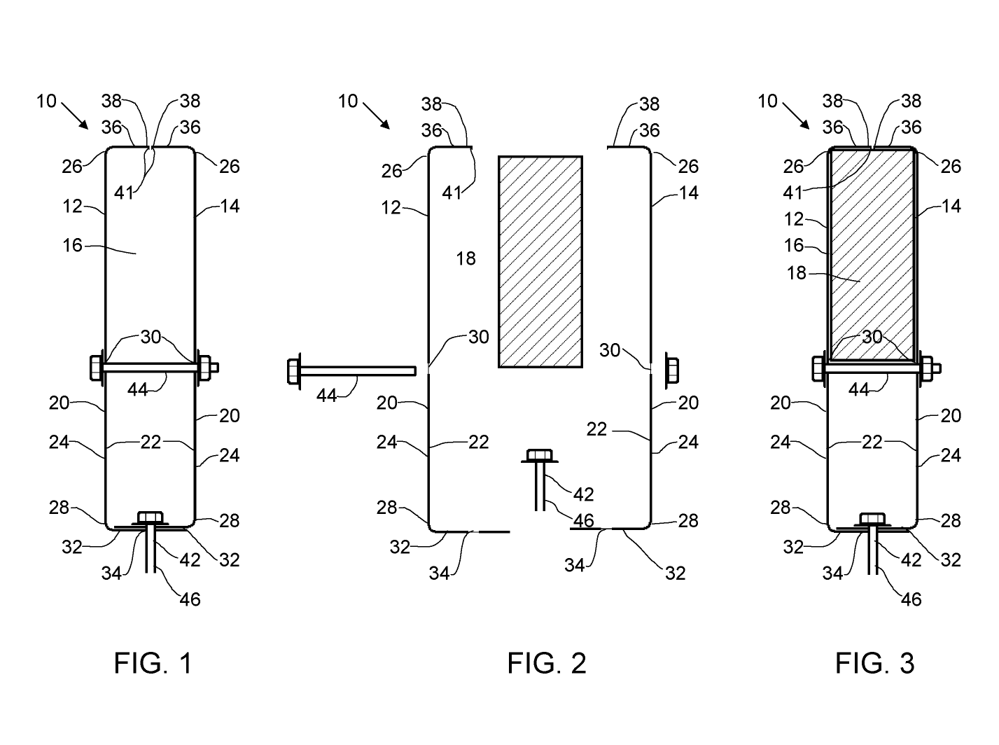

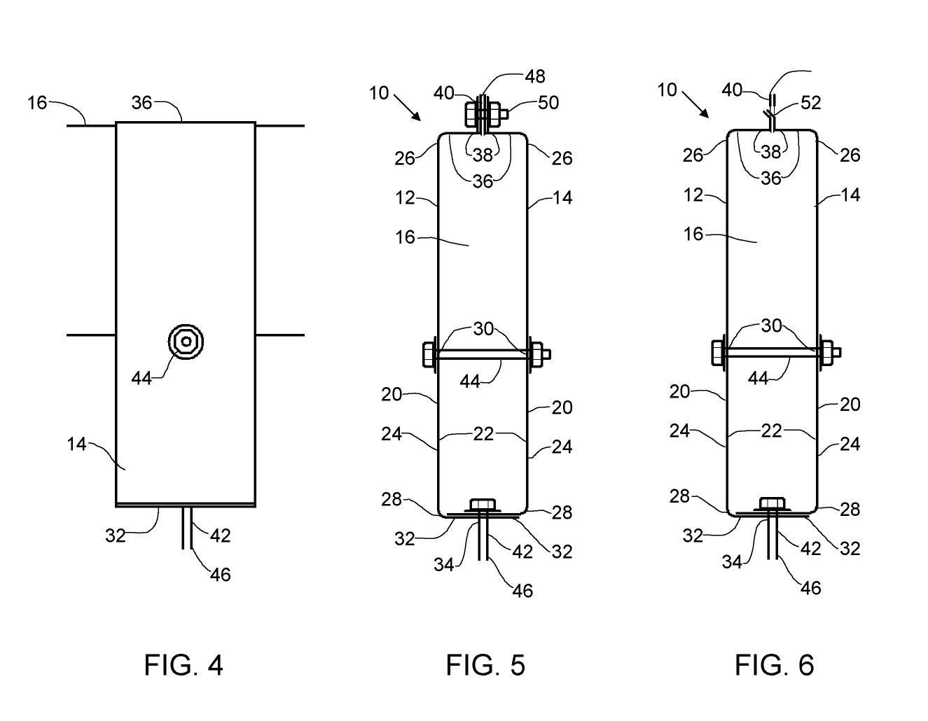

A suspension device generally identified by reference numeral 10 will now be described with reference to FIG. 1 through 6.

### Structure and Relationship of Parts:

Referring to FIG. 1, suspension device has a first body 12 and a second body 14 that, when secured together, define a channel 16 in between to accommodate an elongated horizontal member 18 as shown in FIG. 3.

Referring to FIG. 2, each of first body 12 and second body 14 have a suspension plate 20 having an inside face 22, an outside face 24, an upper end 26 and a lower end 28. Suspension plate 20 has a suspension plate aperture 30 positioned intermediate upper end 26 and lower end 28 that extends between inside face 22 and outside face 24. Suspension plate aperture 30 is preferably positioned immediately below elongated horizontal member 18 when installed on member 18. A lower mounting plate 32 is integrally formed with and extends perpendicularly from inside face 22 at lower end 28 of suspension plate 20. Lower mounting plate 32 has a lower mounting plate aperture 34 extending therethrough. An upper mounting plate 36 is integrally formed with and extends perpendicularly from inside face 22 at upper end 26 of suspension plate 20. A remote end 38 of upper mounting plate 36 carries an abutting engagement profile 40, and preferably a biting edge 41. Lower mounting plate 32 of first body 12 is designed to overlap lower mounting plate 32 of second body 14, while upper mounting plate 36 of first body 12 is intended to butt up against upper mounting plate of second body 14. A first fastener 42 is provided to extend between lower mounting plate apertures 34 of first and second bodies 12 and 14, and a second fastener 44 is provided to extend between suspension plate apertures 30 of first and second bodies 12 and 14. Means, such as an extended portion 46 of first fastener 42, is provided to suspend an object from first fastener 42. Extended portion 46 may be a hook, a loop, or a threaded portion to allow various components to be connected in various ways.

Referring to FIG. 5, engagement profile 40 may be upstanding flanges 48 that are connected by a fastener 50, or referring to FIG. 6, engagement profile 40 may be upstanding flanges 48 that are connected by bending interlocking tabs 52.

### Operation:

Referring to FIG. 2, the various components of suspension device 10 described previously are provided. First body 12 and second body 14 are secured together around elongated horizontal member 18 by overlapping lower mounting plate 32 of first body 12 and lower mounting plate 32 of second body 14 and extending first fastener 42 though lower mounting plate aperture 34 of both first body 12 and second body 14, and by extending second fastener 44 through suspension plate aperture 30 of both first body 12 and second body 14 to clamp first body 12 and second body 14 onto opposite sides of horizontal member 18 and to bring engagement profile 40 on upper mounting plate 36 of first body 12 into engagement with engagement profile 40 on upper mounting plate 36 of second body 14.

Prior to tightening second fastener 44, suspension device 10 may be slid along horizontal member 18 until a desired position is reached. As a downward force is applied on suspension device 10 via first fastener 42, biting edge 41 engages the top of horizontal member 18 to act against horizontal movement. In addition, second fastener 44 is preferably positioned immediately below horizontal member 18, which also helps maintain the relative positions of suspension device 10 and horizontal member 18.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A suspension device, comprising:
a C-shaped first body and a C-shaped second body, each of the first body and the second body having a lower mounting plate with an aperture;
clamping means for clamping the first body and the second body together to define a channel inbetween, with the lower mounting plate of the first body overlapping the mounting plate of the second body;
a suspension fastener from which objects may be suspended, extending through the aperture in the lower mounting plate of the first body and the aperture in the lower mounting plate of the second body.

2. The suspension device of claim 1, wherein the clamping means comprises a nut and bolt that bridges between the first body and the second body.

3. The suspension device of claim 1, wherein each of the first body and the second body have an upper mounting plate, the upper mounting plate of the first body abutting with the mounting plate of the second body when the first body and the second body are clamped together by the clamping means.

4. The suspension device of claim 3, wherein the upper mounting plate of the first body and the upper mounting plate of the second body have biting edges that engage an elongated horizontal member.

5. The suspension device of claim 3, wherein the upper mounting plate of the first body and the upper mounting plate of the second body have two upstanding flanges that are secured together with fasteners.

6. The suspension device of claim 3, wherein the upper mounting plate of the first body and the upper mounting plate of the second body have two upstanding flanges with an interlocking engagement.

7. The suspension device of claim 6, wherein the interlocking engagement are interlocking tabs.

8. A suspension device, comprising:
a first body and a second body which, when secured together, define a channel in between to accommodate an elongated horizontal member, each of the first body and the second body comprising:
a suspension plate having an inside face, an outside face, an upper end and a lower end, the suspension plate having a suspension plate aperture positioned intermediate the upper end and lower end that extends between the inside face and the outside face;
a lower mounting plate integrally formed with and extending perpendicularly from the inside face at the lower end of the suspension plate, the lower mounting plate having a lower mounting plate aperture extending therethrough;
an upper mounting plate integrally formed with and extending perpendicularly from the inside face at the upper end of the suspension plate, a remote end of the upper mounting plate carrying an engagement profile;
the first body and the second body secured together around an elongated horizontal member by overlapping the lower mounting plate of the first body and the lower mounting plate of the second body and extending a first fastener though the lower mounting plate aperture of both the first body and the second body and by extending a second fastener through the suspension plate aperture of both the first body and the second body to bring the engagement profile on the upper mounting plate of the first body into abutting engagement with the engagement profile on the upper mounting plate of the second body;
means to suspend an object from the first fastener.
